(19) United States
(12) Patent Application Publication
(10) Pub. No.: US 2005/0230950 A1
(43) Pub. Date: Oct. 20, 2005

(54) Inflator with stamped end cap

(75) Inventors: Craig M. Fischer, Chandler, AZ (US); William B. Butler, Mesa, AZ (US); Jeffrey A. LaFranier, Gilbert, AZ (US); Christopher J. Ruf, Mesa, AZ (US)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW-Vehicle Safety Systems Inc.

(21) Appl. No.: 10/828,140

(22) Filed: Apr. 20, 2004

(51) Int. Cl. B60R 21/26

(52) U.S. Cl. 280/737

(57) ABSTRACT

An inflator (14) includes a structure (20) that helps define a chamber (30) for containing a volume of inflation fluid (32). A closure member (90) is openable to provide fluid communication between the chamber (30) and an exterior of the inflator (14). A stamped end cap (100) is connectable with the structure (20) to help close the chamber (30). The end cap (100) is made of a steel plate material and has a stamped initiator support portion (112). The initiator support portion (112) has a passage (116) that extends through the end cap (100). An initiator (114) is supported in the initiator support portion (112) of the end cap (100).

### FIELD OF THE INVENTION

The present invention relates to an inflator that provides inflation fluid for inflating an inflatable vehicle occupant protection device.

### BACKGROUND OF THE INVENTION

It is known to inflate an inflatable vehicle occupant protection device to help protect a vehicle occupant in the event of a vehicle collision. One particular type of inflatable vehicle occupant protection device is an inflatable curtain that inflates from the roof of the vehicle downward inside the passenger compartment between a vehicle occupant and the side structure of the vehicle in the event of a side impact or rollover. A known inflatable curtain is inflated from a deflated condition by inflation fluid directed from an inflator to the inflatable curtain through a fill tube.

Another type of inflatable vehicle occupant protection device is an inflatable front air bag. A driver side front air bag is inflated from a stored position in a vehicle steering wheel to a deployed position between an occupant of a front driver side seat and the steering wheel/instrument panel of the vehicle. A passenger side front air bag is inflated from a stored position in the instrument panel to a deployed position between an occupant of a front passenger side seat and the instrument panel.

Another type of inflatable vehicle occupant protection device is a side impact air bag inflatable between the side structure of the vehicle and a vehicle occupant. Side impact air bags may be stored in a variety of locations in the vehicle, such as the side structure, seat, door, or floor of the vehicle. Other types of inflatable vehicle occupant protection devices include inflatable seat belts and inflatable knee bolsters.

### SUMMARY OF THE INVENTION

The present invention relates to an inflator. The inflator includes a structure that helps define a chamber for containing a volume of inflation fluid. A closure member is openable to provide fluid communication between the chamber and an exterior of the inflator. A stamped end cap is connectable with the structure to help close the chamber. The end cap is made of a steel plate material and has a stamped initiator support portion. The initiator support portion has a passage extends through the end cap. An initiator is supported in the initiator support portion of the end cap.

The present invention also relates to an inflator that includes a structure helping to define a chamber for containing a volume of fluid. A primary end cap is connectable with the structure to help close the chamber. The primary end cap includes an outlet passage. A closure member is openable to release the fluid to flow out of the chamber through the outlet passage. A primary initiator is supported on the primary end cap and is actuatable to open the closure member. A stamped secondary end cap is made of a steel plate material and is connectable with the structure to help close the chamber. The secondary end cap includes a stamped initiator support portion. A secondary initiator is supported in the initiator support portion of the secondary end cap.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic block diagram illustrating an apparatus for helping to protect an occupant of a vehicle, according to a first embodiment of the present invention;

FIG. 2 is a schematic sectional view of an inflator of the apparatus of FIG. 1;

FIG. 3 is an exploded view of the inflator of FIG. 2;

FIG. 4 is a schematic sectional view of a portion of an inflator in accordance with a second embodiment of the present invention; and

FIG. 5 is a magnified view of a portion of the apparatus of FIG. 4.

### DESCRIPTION OF A PREFERRED EMBODIMENT

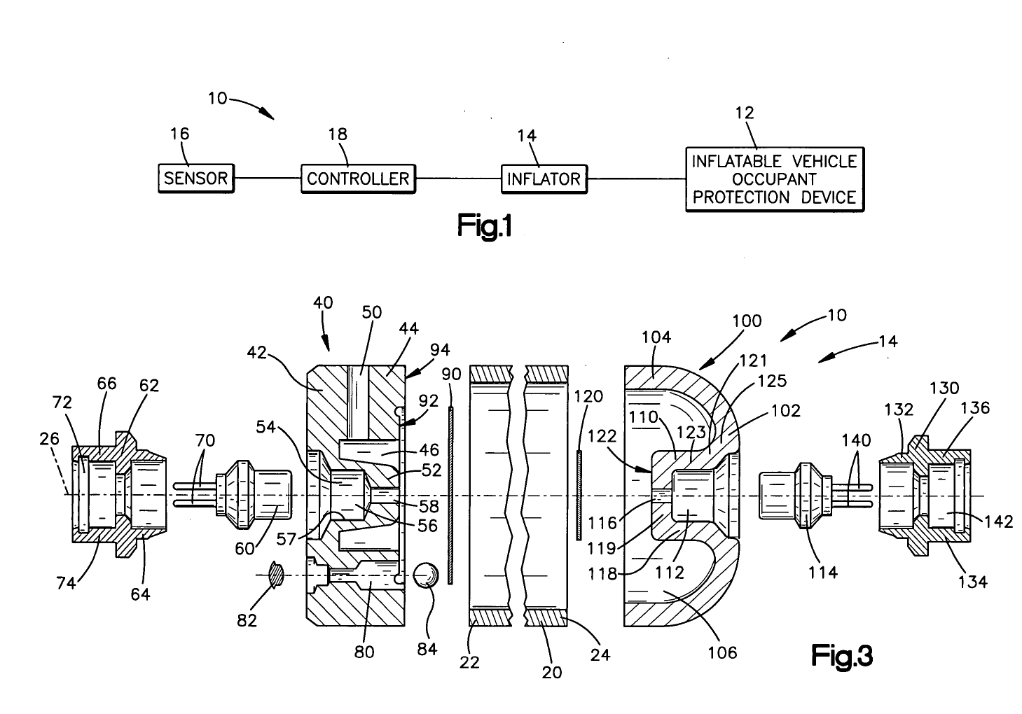

The present invention relates to an apparatus for helping to protect an occupant of a vehicle. In particular, the present invention relates to an inflator for providing inflation fluid for inflating an inflatable vehicle occupant protection device, such as an inflatable curtain or air bag. Representative of the present invention, FIG. 1 illustrates a schematic block diagram of an apparatus 10 for helping to protect an occupant of a vehicle.

In the illustrated embodiment, the apparatus 10 comprises an inflatable vehicle occupant protection device 12. The protection device 12 may have a variety of known configurations. For example, the protection device 12 may be an inflatable curtain, inflatable front impact air bag (driver side or passenger side), a side impact air bag (side structure, door, seat, or floor mounted), an inflatable knee bolster, or an inflatable seat belt.

The apparatus 10 also includes an inflator 14 actuatable to provide inflation fluid for inflating the inflatable vehicle occupant protection device 12. The inflator 14, when actuated, directs inflation fluid into the protection device to inflate the protection device. The protection device 12, when inflated, is deployed to a position for helping to protect a vehicle occupant.

The apparatus 10 also includes a sensor 16 for sensing the occurrence of an event for which inflation of the inflatable vehicle occupant protection device 12 is desired, such as an impact with the vehicle and/or a vehicle rollover. A controller 18, connected with the sensor 16, is operable, upon receiving a signal from the sensor indicating the occurrence of such an event, to actuate the inflator 14. The inflator 14, when actuated, directs inflation fluid into the inflatable vehicle occupant protection device 12 to inflate the protection device. The inflatable vehicle occupant protection device 12, when inflated, is deployed to a position for helping to protect a vehicle occupant.

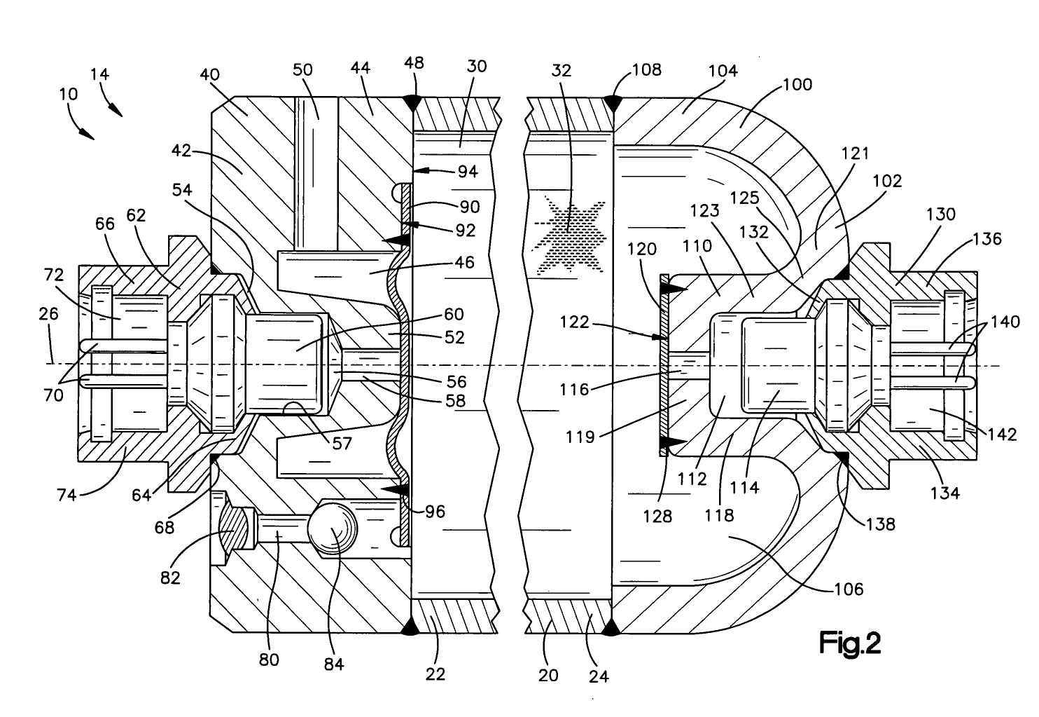

Referring to FIGS. 2 and 3, inflator 14 has a generally cylindrical and elongate configuration. The inflator includes a side wall 20, a primary end cap 40, and a secondary end cap 100. The side wall 20 has a generally elongate cylindrical configuration with a first end 22 and an opposite second end 24. The side wall 20, primary end cap 40, and secondary end cap 100 are aligned with each other along a central axis 26 of the inflator 14.

The primary end cap 40 is connected to the first end 22 of the side wall 20 by means 48 (FIG. 2), such as a weld. The secondary end cap 100 is connected to the second end 24 of the side wall 20 by means 108, such as a weld. The welds 48 and 108 used to connect the primary and secondary end caps 40 and 100 to the first and second ends 22 and 24, respectively, may, for example, be projection welds, friction welds, resistance welds, laser welds, electron beam welds, or arc welds. These types of welds may be used to form any of the other welds described herein.

The side wall 20, primary end cap 40 and secondary end cap 100, when connected, help define a chamber 30 for storing inflation fluid in the inflator 14. The length and diameter of the side wall 20 help determine the volume of the chamber 30. The length and/or diameter of the side wall 20 may thus be selected to provide a desired chamber volume. The inflation fluid stored in the inflator 14 may vary depending on the type of inflator. According to the first embodiment of the present invention, the inflator 14 is a heated gas inflator.

According to the heated gas construction of the inflator 14 of the present invention, a supply of inflation fluid 32 for inflating the inflatable vehicle occupant protection device 12 is stored in the chamber 30. The inflation fluid 32 includes an oxidizer gas and a combustible fuel gas. Examples of suitable oxidizer gasses include oxygen and air. Examples of suitable fuel gasses include hydrogen, nitrous oxide, and methane. In one embodiment of the present invention, the inflation fluid 32 comprises a mixture of air and hydrogen.

The inflation fluid 32 may also comprise one or more inert gasses, such as nitrogen, argon, or a mixture of nitrogen and argon. The inflation fluid 32 may further include a tracer gas, such as helium, for helping to detect leaks.

The inflation fluid 32 is stored in the chamber 30 under pressure. The pressure under which the inflation fluid 32 is stored may depend on a variety of factors, such as the volume of the inflatable vehicle occupant protection device 12 to be inflated, the time available for inflation, the inflation pressure desired, and the volume of the chamber 30 of the inflator 12. For example, the inflation fluid 32 may be stored in the chamber 30 at a pressure of about 2,000 to about 8,000 pounds per square inch (psi), or more.

The primary end cap 40 (FIGS. 2 and 3) has a generally cylindrical configuration with an outside diameter that is about equal to the outside diameter of the side wall 20. The primary end cap 40 includes an end wall 42 centered on the axis 26 and an annular side wall 44 that extends from the end wall in a direction generally parallel to the axis. The end wall 42 and the side wall 44 help define a concave recess 46 of the primary end cap 40. The primary end cap 40 may include one or more outlet passages 50 that extend through the side wall 44 and provide fluid communication between the recess 46 and an exterior of the primary end cap.

The primary end cap 40 also includes a support portion 52 that extends into the recess 46 from the end wall 42. The support portion 52 is centered on the axis 26 and extends along the axis away from the end wall 42. A multi-diameter bore 54 extends through the end wall 42 and through the support portion 52. The bore 54 defines an initiator support portion 56 configured to receive a primary initiator 60, such as a squib. The initiator support portion 56 has a multi-diameter cylindrical side wall 57 formed by the bore 54. The bore 54 also includes a passage 58 that provides fluid communication between the initiator support portion 56 and the recess 46 of the primary end cap 40.

An interface housing 62 is connected to the primary end cap 40 by means 68, such as a weld. The interface housing 62 has a retainer portion 64 that extends into the initiator support portion 56 of the primary end cap 40. As shown in FIG. 2, the interface housing 62 is crimped onto the primary initiator 60 to retain the initiator in the initiator retainer portion 64. The interface housing 62 may thus help support the primary initiator 60 in the initiator support portion 56 of the primary end cap 40 adjacent the passage 58.

The interface housing 62 has a connector portion 66 positioned opposite the retainer portion 64. When the interface housing 62 is crimped onto the primary initiator 60 (see FIG. 2), lead pins 70 of the primary initiator 60 extend into a recess 72 in the connector portion 66. The connector portion 66 has a side wall 74 configured to engage with and lock onto an electrical connector (not shown), which also connects with the lead pins 70 to provide an electrical signal via the lead pins for actuating the primary initiator 60.

The primary end cap 40 also includes a fill passage 80 for introducing the inflation fluid 32 into the chamber 30 of the inflator 14. The fill passage 80 has a first end portion in which a stop piece 82 is welded to help seal the passage and help prevent leakage of the inflation fluid 32. The fill passage 80 has a second end portion, opposite the first end portion, in which a ball stop 84 is supported. The ball stop 84 in the second end portion acts as a check valve that permits filling the chamber 30 with inflation fluid 32 and also isolates the inflation fluid in the chamber, which helps prevent leakage of the fluid from the chamber while the stop piece 82 is welded.

The inflator 14 also includes a closure member 90, sometimes referred to as a burst disk. The closure member 90 has a thin, disk-shaped configuration and is seated on an annular rim surface 92 formed on an end surface 94 of the side wall 44 of the primary end cap 40. The closure member 90 is fixed to the primary end cap 40 by means 96 (FIG. 2), such as a weld or an adhesive. As shown in FIG. 2, the closure member 90 may become deformed into engagement with the support portion 52 when the inflation fluid 32 is pressurized in the chamber 30. The closure member 90 blocks fluid communication between the chamber 30 and the recess 46 and outlet passages 50.

The secondary end cap 100 has a generally cylindrical configuration with an outside diameter that is about equal to the outside diameter of the side wall 20. The secondary end cap 100 includes an end wall 102 centered on the axis 26 and an annular side wall 104 that extends from an outer periphery of the end wall in a direction generally parallel to the axis. The end wall 102 and the side wall 104 help define a concave recess 106 of the secondary end cap 100.

The secondary end cap 100 also includes an initiator support portion 110 that extends into the recess 106 from the end wall 102. The initiator support portion 110 is centered on the axis 26 and extends along the axis away from the end wall 102. The initiator support portion 110 has a side wall 118 and an end wall 119 that help define a recess 112 configured to receive a secondary initiator 114, such as a squib. The side wall 118 has a frustoconical first portion 121 and a cylindrical second portion 123 that extends from a small diameter end of the first portion. The first portion 121 forms an annular shoulder 125 of the initiator support portion 110.

The initiator support portion 110 includes a passage 116 that extends through the end wall 119 and provides fluid communication between the recess 112 and the recess 106 of the secondary end cap 100. An isolation disk 120 is connected to an annular end surface 122 formed by the end wall 119 of the initiator support portion 110 by means 128, such as a weld or an adhesive. The isolation disk 120, when connected to the initiator support portion 110, blocks fluid communication between the recess 112 and the recess 106 through the passage 116.

An interface housing 130 has a retainer portion 132 that extends into the recess 112 in the initiator support portion 110 of the secondary end cap 100. As shown in FIG. 2, the interface housing 130 is crimped onto the secondary initiator 114 to retain the initiator in the recess 112 of the initiator support portion 110 and to form an assembly with the secondary initiator.

The assembly of the interface housing 130 and the initiator 114 is positioned in the initiator support portion 110 such that the interface housing is seated against the shoulder portion 125. The interface housing 130 is connected to the secondary end cap 100 by means 138, such as a weld, which connects the assembly of the interface housing and the initiator 114 to the secondary end cap 100. The interface housing 130 thus helps support the secondary initiator 114 in the recess 112 of the initiator support portion 110 of the secondary end cap 100 adjacent the passage 116.

The interface housing 130 has a connector portion 134 positioned opposite the retainer portion 132. When the interface housing 130 is crimped onto the secondary initiator 114 (see FIG. 2), lead pins 140 of the secondary initiator 114 extend into a recess 142 in the connector portion 134. The connector portion 134 has a side wall 136 configured to interface with and lock onto an electrical connector (not shown), which also connects with the lead pins 140 to provide an electrical signal via the lead pins for actuating the secondary initiator 114.

The side wall 20, primary end cap 40, and secondary end cap 100 may be formed from a variety of materials. According to the present invention, side wall, primary end cap 40 and secondary end cap 100 are formed from a high-strength, low-carbon steel. The side wall 20 is formed from a length of seamless, cold drawn tubing made of high-strength, low-carbon steel. The primary end cap 40 is machined from a length of high-strength, low-carbon steel bar stock. The machined configuration of the primary end cap 40 is necessitated by the relatively complex features of the primary end cap, such as the multi-diameter fill passage 80 and the radially extending outlet passages 50.

According to the present invention, the secondary end cap 100 is stamped from a sheet of high-strength, low-carbon steel plate or sheet stock. The secondary end cap 100 may be stamped in a single operation in which the passage 116 is punched while simultaneously stamping the plate to form the end wall 102, side wall 104, and initiator support portion 110. The secondary end cap 100 may thus be constructed as a single piece of homogeneous stamped steel sheet material. The end wall 102, side wall 104, and initiator support portion 110, having a relatively simple configuration and generally uniform wall thickness, help make possible the stamped construction of the secondary end cap 100.

It is known that steel has a crystalline structure in which the metal has a grain. The grain of a given piece of steel runs in a general direction along which the piece of steel was worked during its formation. It is also known that steel may include microscopic inclusions or voids that extend along the grain of the steel.

The grain in a piece of seamless steel tubing runs longitudinally along the length of the tubing. The grain in a piece of steel bar stock runs longitudinally along the length of the bar. The grain in a piece of steel sheet stock runs in a direction generally perpendicular to the thickness of the sheet.

The sheet stock used to form the secondary end cap 100 may be formed in a variety of manners. For example, the sheet stock may be formed by mechanically treating a slug of high strength, low-carbon steel to form the sheet. The slug of steel may begin the process having a thickness of several inches. The thickness of the slug is reduced to the desired sheet thickness through the mechanical treatment of the slug. The mechanical treatment may include steps such as hot rolling and cold rolling. The hot and/or cold rolling process may be repeated several times in order to achieve the desired sheet thickness. Through this rolling of the steel, the grain of the steel sheet is formed to run along the length of the sheet in a direction generally perpendicular to the thickness of the sheet.

The inflation fluid 32, when stored under pressure in the chamber 30 of the inflator 14, exerts a force that acts outwardly against the side wall 20, primary end cap 40, and secondary end cap 100. Those skilled in the art will appreciate that the grain and the inclusions in the steel components of the inflator 14 may create a path through which the inflation fluid 32 may permeate or leak. This is especially the case where, as in the present invention, the inflation fluid 32 includes gasses, such as hydrogen, that have small molecular weights.

According to the present invention, the inflator 14 is constructed so as to help minimize leakage of inflation fluid 32 through the grain or inclusions in the steel components used to construct the inflator. The side wall 20, being constructed of cold drawn steel tubing, has a grain that runs in a direction generally parallel to the axis 26. The grain and inclusions of the side wall 20 thus do not run in a direction that would form a path that extends through the thickness of the tube. The construction of the side wall 20 thus helps prevent leakage of inflation fluid 32 through the side wall.

The primary end cap 40, being constructed of steel bar stock material, has a grain that run in a direction generally parallel to the axis 26. The grain and inclusions in the primary end cap 40 may thus form a path that extends through the thickness of the primary end cap. It will be appreciated, however, that the closure member 90, being connected to the primary end cap 40 and formed of sheet material, helps block inflation fluid from escaping through the grain and any inclusions in the primary end cap. Also, the primary end cap 40 has a relatively large thickness and thus is less prone to leakage.

According to the present invention, the secondary end cap 100, being stamped from a steel plate material, has a grain and inclusions that extend in a direction that follows the contour of the secondary end cap. In other words, the grain and inclusions of the secondary end cap 100 extend in a direction generally perpendicular to the thickness of the secondary end cap. Advantageously, the grain and inclusions of the secondary end cap 100 thus do not extend in a direction that would form a path that extends through the thickness of the end cap. The construction of the side wall end cap 100 thus helps prevent leakage of inflation fluid 32 through the end cap. As another advantage, the secondary end cap 100, being stamped in a single manufacturing step, may be less costly to produce than an end cap machined from bar stock, such as the primary end cap 40, which may require a series of manufacturing steps.

Referring to FIG. 1, upon sensing the occurrence of an event for which inflation of the inflatable vehicle occupant protection device 12 is desired via the sensors 16, the controller 18 triggers actuation of the inflator 14 to effectuate inflation of the inflatable vehicle occupant protection device. Depending on the type of event sensed by the controller 18, the controller may selectively actuate only the primary initiator 60 or both the primary initiator and the secondary initiator 114. The controller may actuate the secondary initiator 114 simultaneously with the primary initiator 60 or after a time delay.

The primary initiator 60, when actuated, ruptures the closure member 90 and ignites the hydrogen fuel gas portion of the inflation fluid 32. Rupture of the closure member 90 releases the inflation fluid 32 to flow through the outlet passages 50 and into the inflatable vehicle occupant protection device 12. Ignition of the hydrogen fuel gas adds heat to the inflation fluid 32. The inflatable vehicle occupant protection device 12 inflates and deploys to a position in the vehicle for helping to protect a vehicle occupant.

The secondary initiator 114, when actuated, ruptures the isolation disk 120 and serves as a secondary source for igniting the hydrogen fuel gas portion of the inflation fluid 32. This additional source of ignition helps produce a more rapid burn of the hydrogen fuel gas, which increases the heat added to the inflation fluid 30 and increases the output of the inflator 14. This may help reduce the inflation and deployment time of the inflatable vehicle occupant protection device 12 from that in which only the primary initiator 60 is actuated. The secondary initiator 114 may thus be actuated by the controller 18 upon sensing the occurrence of an event for which a more rapid inflation and deployment of the inflatable vehicle occupant protection device 12 is desired.

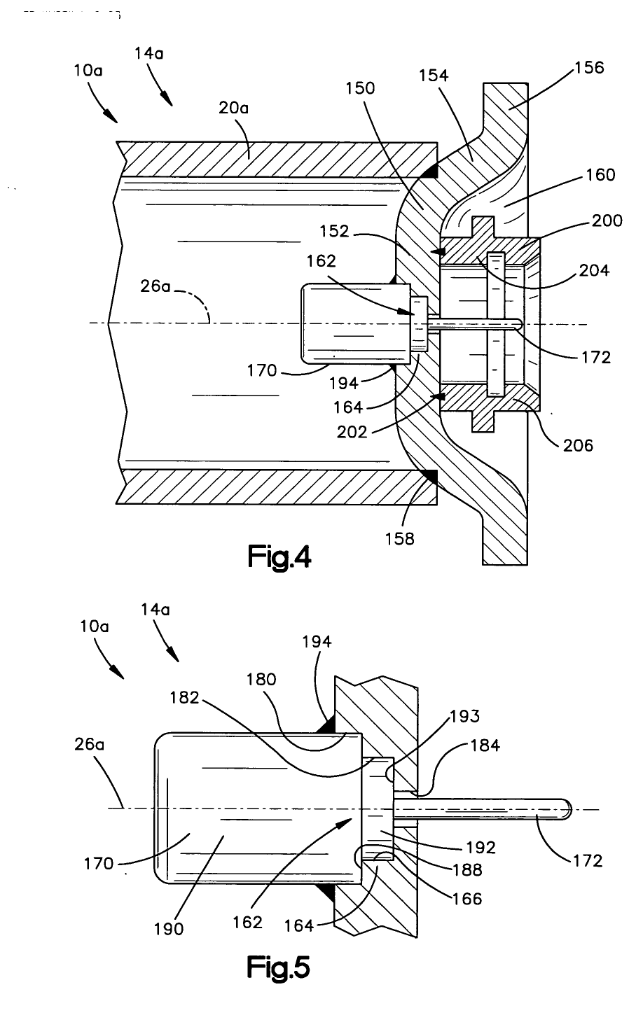

An inflator in accordance with a second embodiment of the present invention is illustrated in FIGS. 4 and 5. The inflator of the second embodiment of the invention is similar to the inflator of first embodiment of the invention illustrated in FIGS. 1-3. Accordingly, numerals similar to those of FIGS. 1-3 will be utilized in FIGS. 4 and 5 to identify similar components, the suffix letter “a” being associated with the numerals of FIGS. 4 and 5 to avoid confusion. The inflator of the second embodiment of the present invention is similar to the inflator of the first embodiment (FIGS. 1-3), except that the secondary end cap of the second embodiment has a configuration different than that of the first embodiment.

According to the second embodiment, the apparatus 10a includes an inflator 14a that includes a side wall 20a, a primary end cap (not shown) and a secondary end cap 150. The primary end cap may be identical to the primary end cap of the first embodiment (see FIGS. 2 and 3) and therefore is not shown in FIG. 4. The secondary end cap 150 is connected to the side wall 20a by means 158, such as a weld.

The secondary end cap 150 includes an end wall 152 centered on the axis 26a. The end wall 152 has a diameter smaller than the diameter of the side wall 20a and is thus encircled by the side wall 20a. A tapered side wall 154 of the secondary end cap 150 extends from an annular periphery of the end wall 152 at an acute angle with the axis 26a and away from the axis. A flange portion 156 extends transverse to the side wall 154 at an end of the side wall opposite the end wall 152. The flange portion 156 extends generally perpendicular to the axis 26a. The flange portion 156 may be used for handling or mounting the inflator 14a.

The side wall 154 has a generally frustoconical configuration tapered from a diameter adjacent the end wall 152 that is smaller than the inside diameter of the side wall 20a to a diameter adjacent the flange portion 156 that is larger than the outside diameter of the side wall. The side wall 154 of the secondary end cap 150 is connected to the side wall 20a by the weld 158 at the location where the outside of the side wall 154 intersects the inside of the side wall 20a.

The end wall 152 and the side wall 154 help define a concave recess 160 of the secondary end cap 150. A multi-diameter cylindrical passage 162 is centered on the axis 26a and extends through the end wall 152 of the secondary end cap 150. The passage 162 is defined by an initiator support portion 164 of the secondary end cap 150 that is configured to receive and mate with a secondary initiator 170, such as a squib.

Referring to FIG. 5, the initiator support portion 164 has a side wall 166 that helps define the passage 162. The side wall 166 includes a first portion 180 having a first diameter, second portion 182 having a second diameter smaller than the first diameter, and third portion 184 having a third diameter smaller than the second diameter. The secondary initiator 170 has a cylindrical configuration with a main body portion 190 that has a diameter just smaller than the first diameter of the first portion 180. The secondary initiator 170 has a terminal end portion 192 that has a diameter just smaller than the second diameter of the second portion 182.

The secondary initiator 170 is received in the initiator support portion 164 with the main body portion 190 seated against an annular shoulder 188 of the initiator support portion 162 that extends between the first and second portions 180 and 182 of the side wall 166. The terminal end portion 192 of the second initiator 170 is seated against an annular shoulder 193 that extends between the second and third portions 182 and 184 of the side wall 166. Means 194, such as a weld, fixedly connects the secondary initiator 170 to the end wall 152 of the secondary end cap 150. The secondary initiator 170 includes leads 172 that extend through the passage 162 and into the recess 160 when the secondary initiator 170 is fixed to the secondary end cap 150.

An interface housing 200 is connected to the secondary end cap 150 by means 202, such as a weld. The interface housing 200 has a connector portion 204 that includes a side wall 206 configured to engage with and lock onto an electrical connector (not shown), which also connects with the lead pins 172 to provide an electrical signal via the lead pins for actuating the secondary initiator 170.

According to the present invention, the secondary end cap 150 is stamped from a sheet of high-strength, low-carbon steel plate or sheet stock. The secondary end cap 150 may be stamped in a single operation in which the passage 162 is punched while simultaneously stamping the plate to form the end wall 152, side wall 154, and flange portion 156. It will be appreciated that the passage 162 could, however, be formed in a separate manufacturing step. The stamped construction of the secondary end cap 150 is possible due to the fact that the end wall 152, side wall 154, and flange portion 156 have a generally uniform wall thickness and are aligned coaxially with each other.

The secondary end cap 150, being stamped from a steel plate material, advantageously causes the grain of the steel to run transverse to the thickness of the end cap. As described above in regard to the first embodiment, the grain and inclusions of the secondary end cap 150 do not extend in a direction that would form a path that extends through the thickness of the end cap. The construction of the secondary end cap 150 thus helps prevent leakage of inflation fluid through the end cap. The secondary end cap 150 may also be less costly to produce than an end cap machined from bar stock, which may require a series of manufacturing steps.

From the above description of the invention, those skilled in the art will perceive improvements, changes and modifications. Such improvements, changes and modifications within the skill of the art are intended to be covered by the appended claims.

1. An inflator comprising:
a structure helping to define a chamber for containing a volume of inflation fluid;
a closure member openable to provide fluid communication between said chamber and an exterior of said inflator;
a stamped end cap connectable with said structure to help close said chamber, said end cap being made of a steel plate material, said end cap having a stamped initiator support portion, said initiator support portion comprising a passage extending through said end cap; and
an initiator supported in said initiator support portion of said end cap.

2. The inflator recited in claim 1, further comprising:
a primary end cap connectable with said structure to help close said chamber, said primary end cap including an outlet passage; and
a primary initiator supported on said primary end cap, said primary initiator on said primary end cap being actuatable to open said closure member, said closure member when opened releasing inflation fluid to flow out of said inflator through said outlet passage.

3. The inflator recited in claim 2, wherein said structure comprises a side wall having a first end portion including a first opening and an opposite second end portion including a second opening, said primary end cap being connected with said first end portion to help close said first opening, said stamped end cap being connected with said second end portion to help close said second opening.

4. The inflator recited in claim 2, wherein said primary initiator comprises a primary ignition source for igniting said inflation fluid and said initiator supported on said stamped end cap comprises a secondary ignition source for igniting said inflation fluid.

5. The inflator recited in claim 4, further comprising means for selectively actuating said secondary ignition source at a predetermined time after actuating said primary ignition source.

6. The inflator recited in claim 1, wherein said structure comprises a cylindrical side wall having an inside diameter and an outside diameter, said end cap comprising a frustoconical side wall with an outside diameter tapered from a first diameter smaller than said inside diameter of said side wall to a second diameter larger than said outside diameter of said side wall, said side wall of said end cap being connectable with said side wall of said structure.

7. The inflator recited in claim 1, wherein said passage of said initiator support portion exposes a portion of the initiator supported in said initiator support portion to said chamber.

8. The inflator recited in claim 1, wherein said initiator support portion of said end cap is adapted to receive a retainer for helping to support the initiator in said initiator support portion.

9. The inflator recited in claim 1, wherein said initiator support portion comprises a side wall defining an annular shoulder for helping to support said initiator.

10. The inflator recited in claim 1, further comprising an initiator retainer connectable with said initiator to form an assembly connectable with said stamped end cap, said initiator support portion comprising an annular shoulder portion against which said initiator retainer is seated when said assembly is connected with said stamped end cap.

11. The inflator recited in claim 1, wherein said initiator support portion includes a side wall having a first portion with a first diameter and a second portion with a second diameter larger than said first diameter, said first and second portions of said side wall helping to define an annular shoulder for helping to support said initiator, said side wall defining a passage that extends through said stamped end cap.

12. The inflator recited in claim 1, wherein said inflation fluid comprises a fuel gas mixture including a mixture of hydrogen and air, said initiator being actuatable to ignite said inflation fluid.

13. The inflator recited in claim 1, wherein said passage provides fluid communication between said initiator support portion and said chamber.

14. The inflator recited in claim 1, wherein said end cap consists essentially of a single homogeneous piece of stamped steel plate material.

15. An inflator comprising:
a structure helping to define a chamber for containing a volume of fluid;
a primary end cap connectable with said structure to help close said chamber, said primary end cap including an outlet passage;
a closure member openable to release said fluid to flow out of said chamber through said outlet passage;
a primary initiator supported on said primary end cap, said primary initiator being actuatable to open said closure member;
a stamped secondary end cap connectable with said structure to help close said chamber, said secondary end cap being made of a steel plate material, said secondary end cap having a stamped initiator support portion; and
a secondary initiator supported in said initiator support portion of said secondary end cap.

16. The inflator recited in claim 15, wherein said volume of fluid comprises a fuel gas mixture stored under pressure, said primary initiator being actuatable to open said closure member and provide a primary ignition source for igniting said fuel gas mixture, said secondary initiator being actuatable to provide a secondary ignition source for igniting said fuel gas mixture.
